(19) United States
(12) Patent Application Publication
(10) Pub. No.: US 2011/0199623 A1
(43) Pub. Date: Aug. 18, 2011

(54) IMAGE PROCESSING APPARATUS AND SETTING METHOD USED IN IMAGE PROCESSING APPARATUS

(75) Inventor: Hiroyuki Okuyama, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/021,059

(22) Filed: Feb. 4, 2011

Related U.S. Application Data
(60) Provisional application No. 61/303,944, filed on Feb. 12, 2010.

(51) Int. Cl. G06F 15/00

(52) U.S. Cl. 358/1.9

(57) ABSTRACT

According to one embodiment, an image processing apparatus has a storage unit, a display unit, a display control unit, a setting log saving unit, a determination unit, and an updating unit. The storage unit stores default settings. The display unit displays setting contents reflecting the default settings. The display control unit causes the setting contents which are changed in response to an instruction from a user to be displayed on the display unit. The setting log saving unit saves the setting contents of the executed process as setting log information. The determination unit determines whether or not the default settings are to be changed using a plurality of the setting log information. The updating unit, if it is determined that the default settings are to be changed, updates the default settings to default settings determined from the plurality of the setting log information.

### CROSS-REFERENCE TO RELATED APPLICATIONS

This application is based upon and claims the benefit of priority from U.S. Provisional Application No. 61/303,944 filed on Feb. 12, 2010; the entire contents of which are incorporated herein by reference.

### FIELD

Embodiments described herein relate generally to an image processing apparatus and a setting method used in an image processing apparatus.

### BACKGROUND

An image processing apparatus such as a digital multi-functional peripheral is set by each user depending on the purposes and preference of the user in use. The image processing apparatus such as the digital multi-functional peripheral instructs a setting item that the user wants to change from default settings. Accordingly, as contents of the default settings are closer to the purposes and preference desired by the user, operability of the user is enhanced. However, in the image processing apparatus such as the digital multi-functional peripheral, purposes and preferences desired by individual users are not always the same. That is, in the image processing apparatus such as the digital multi-functional peripheral according to the related art, there is a problem in that it is difficult to provide default settings depending on purposes and preferences desired by users.

### BRIEF DESCRIPTION OF THE DRAWINGS

FIG. 1 is a diagram illustrating an example of the outer configuration of a digital multi-functional peripheral.

FIG. 2 is a cross-sectional view illustrating an example of the configuration of the digital multi-functional peripheral.

FIG. 3 is a diagram illustrating an example of the configuration of a control panel.

FIG. 4 is a block diagram for explaining an example of the configuration of a control system in the digital multi-functional peripheral.

FIG. 5 is a diagram illustrating an example of the configuration of a default setting database.

FIG. 6 shows an example of the configuration of a setting log database.

FIG. 7 is a diagram showing an example of the configuration of an aggregation database.

FIG. 8 is a diagram conceptually showing a learning function of default settings.

FIG. 9 is a flowchart for explaining the learning function of the default settings.

### DETAILED DESCRIPTION

In general, according to one embodiment, an image processing apparatus has a storage unit, a display unit, a display control unit, a setting log saving unit, a determination unit, and an updating unit. The storage unit stores default settings. The display unit displays setting contents reflecting the default settings stored in the storage unit. The display control unit causes the setting contents which are changed in response to an instruction from a user to be displayed on the display unit. The setting log saving unit, if image processing is executed using the setting contents displayed on the display unit, saves the setting contents of the executed process as setting log information. The determination unit determines whether or not the default settings stored in the storage unit are to be changed using a plurality of pieces of the setting log information saved in the setting log saving unit. The updating unit, if it is determined that the default settings are to be changed by the determination unit, updates the default settings stored in the storage unit to default settings determined from the plurality of pieces of the setting log information saved in the setting log saving unit.

Hereinafter, embodiments will be described in detail with reference to the accompanying drawings.

First, the configuration of a digital multi-functional peripheral (MFP) as an image processing apparatus will be described.

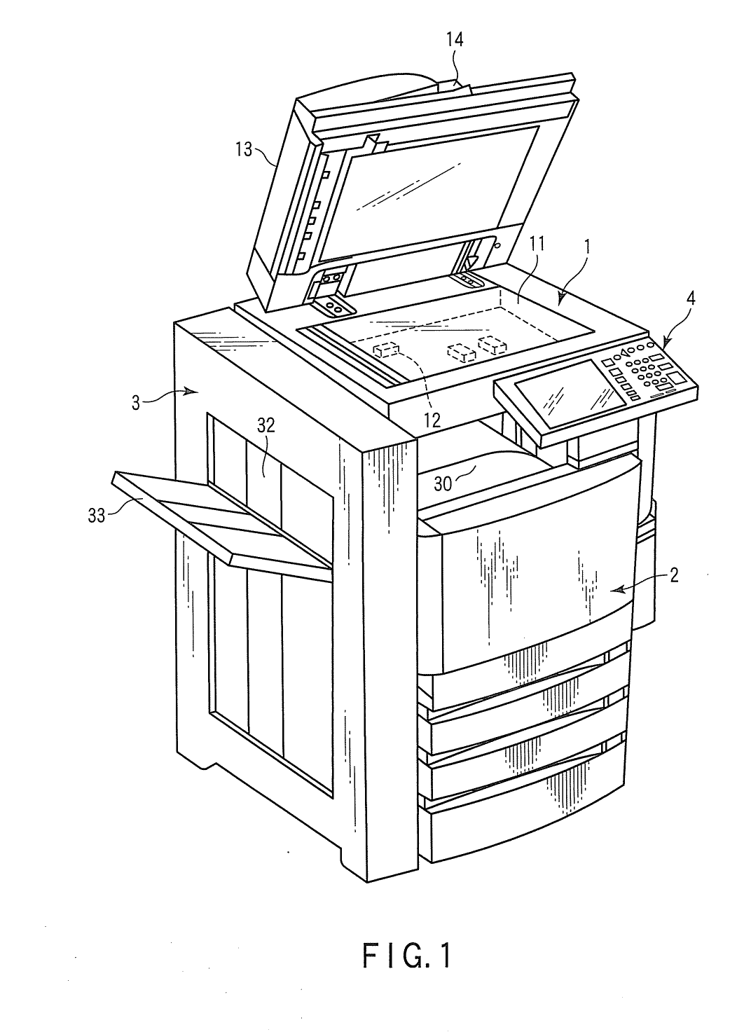

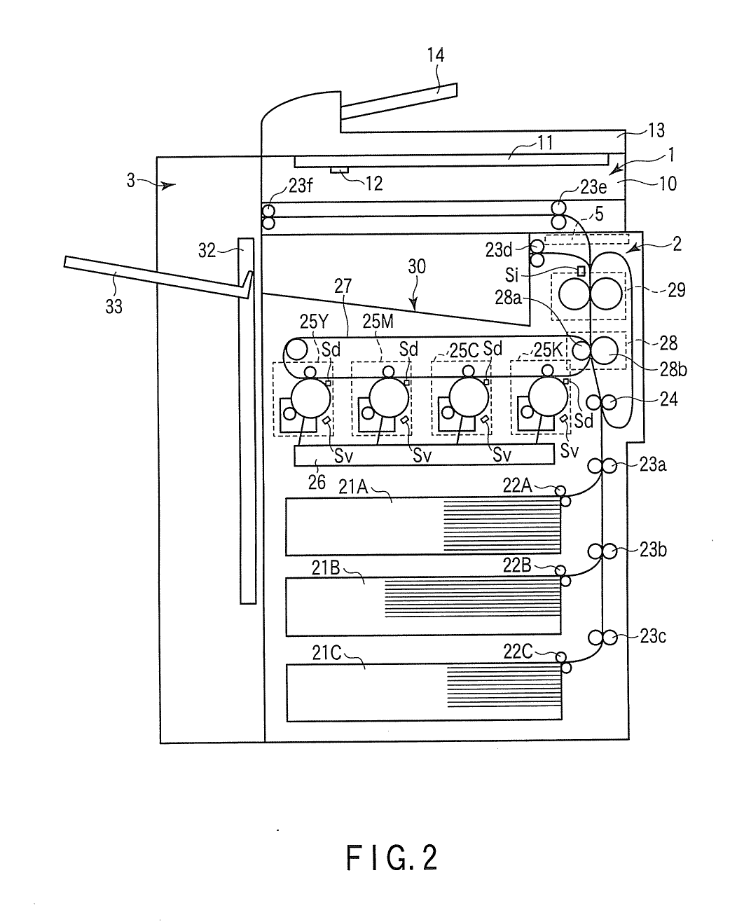

FIG. 1 is a perspective view illustrating an example of the outer configuration of the digital multi-functional peripheral. In addition, FIG. 2 is a cross-sectional view schematically illustrating an example of the internal configuration of the digital multi-functional peripheral. As illustrated in FIG. 1, the digital multi-functional peripheral has a scanner 1, a printer 2, a finisher 3, a control panel 4, and a system controller 5.

The scanner 1 is installed at the upper portion of the main body of the digital multi-functional peripheral. The scanner 1 is controlled by the system controller 5. The scanner 1 is a device that reads an image of an original document and converts the read image into image data. The scanner 1 outputs the image data on the original document to the system controller 5.

The scanner 1 has an image reading unit 10 as a photoelectric conversion unit including a CCD line sensor that converts one line of the image of the original document in a main scanning direction into image data. The image reading unit 10 reads the entire image of the original document by scanning the original document in a sub-scanning direction using the CCD line sensor.

The scanner 1 has a platen glass 11 and an original document sensor 12. On the platen glass 11, the original document scanned by the image reading unit 10 is placed. The image reading unit 10 scans the original document on the platen glass 11 through glass of the platen glass 1. The original document sensor 12 senses the original document on the platen glass 11. The original document sensor 12 outputs a signal for representing existence of the original document on the platen glass 11. The original document sensor 12 senses the size of the original document on the platen glass 11.

The scanner 1 has an auto document feeder (ADF) 13. The ADF 13 has a paper feed tray 14. The paper feed tray 14 holds original documents to be read. The ADF 13 carries the original documents held by the paper feed tray 14 sheet by sheet. The scanner 1 reads images of the original documents carried by the ADF 13. In the scanner 1, the ADF 13 also functions as a cover for the original document placed on the platen glass 11. The ADF 13 is mounted on the platen glass 11 in the main body of the digital multi-functional peripheral while the entirety thereof can be opened and closed.

The printer 2 is controlled by the system controller 5. The printer 2 prints image data supplied from the system controller 5 on a sheet as an image forming medium.

The printer 2 has paper feed cassettes 21A, 21B, and 21C. The paper feed cassettes 21A, 21B, and 21C store the sheets as the image forming media on which images are printed. For example, each of the paper feed cassettes 21A, 21B, and 21C is attachable to or detachable from the lower portion of the main body of the digital multi-functional peripheral. The paper feed cassettes 21A, 21B, and 21C respectively have paper feed rollers 22A, 22B, and 22C. The paper feed rollers 22A, 22B, and 22C take out the sheets one by one respectively from the paper feed cassettes 21A, 21B, and 21C.

A carrying unit 23 carries the sheet in the printer 2. The carrying unit 23 has a plurality of carrying rollers 23a to 23f and a registration roller 24. The carrying unit 23 carries the sheet taken out by each of the paper feed rollers 22A, 22B, and 22C to the registration roller 24. The registration roller 24 carries the sheet to a transfer position at a timing at which an image is transferred.

A plurality of image forming units 25 (25Y, 25M, 25C, and 25K) forms images of respective colors (yellow, magenta, cyan, and black). An exposure unit 26 forms electrostatic latent images as images developed on photoconductive drums Dy, Dm, Dc, and Dk as image holding members with corresponding colors in the respective image forming units 25 (25Y, 25M, 25C, and 25K). The image forming units 25 (25Y, 25M, 25C, and 25K) form toner images by developing the electrostatic latent images formed on the respective photoconductive drums Dy, Dm, Dc, and Dk using toner of the corresponding colors (yellow, magenta, cyan, and black). An intermediate transfer belt 27 is an intermediate transfer body. The image forming units 25 (25Y, 25M, 25C, and 25K) transfer the toner images of the corresponding colors formed on the respective photoconductive drums Dy, Dm, Dc, and Dk onto the intermediate transfer belt 27 (primary transfer).

In addition, each of the image forming units 25 (25Y, 25M, 25C, and 25K) has sensors such as a potential sensor Sv and a density sensor Sd. The potential sensor Sv is a sensor that senses the surface potential of the photoconductive drum. In the image forming units 25 (25Y, 25M, 25C, and 25K), the surfaces of the respective photoconductive drums are charged by chargers before being exposed by the exposure unit 26. The potential sensor Sv senses the surface potential of the photoconductive drum after the surface of the photoconductive drum is charged by the charger. The density sensor Sd senses the density of the toner image transferred onto the intermediate transfer body 27. In addition, the density sensors Sd may sense the toner images formed on the photoconductive drums Dy, Dm, Dc, and Dk.

The image forming units 25Y, 25M, 25C, and 25K overlap and transfer (primarily transfer) the toner images developed with the toner of the corresponding colors (yellow, magenta, cyan, and black) onto the intermediate transfer belt 27. The intermediate transfer belt 27 holes a color image formed by overlapping the toner images of the corresponding colors. A transfer unit 28 transfers the color image with the toner of the plurality of colors on the intermediate transfer belt 27 onto a sheet at a secondary transfer position. The secondary transfer position is a position at which the toner image on the intermediate transfer belt 27 is transferred on the sheet. The secondary transfer position is a position at which a support roller 28a and a secondary transfer roller 28b oppose each other.

The registration roller 24 carries the sheet to the secondary transfer position according to a timing regarding the toner image on the intermediate transfer belt 27. The transfer unit 28 supplies the sheet onto which the toner image is transferred at the secondary transfer position to a fixing unit 29. The fixing unit 29 fixes the toner image onto the sheet. The fixing unit 29 heats the sheet onto which the toner image is transferred by the transfer unit 28 in a pressurized state. The fixing unit 29 carries (discharges) the sheet subjected to the fixing to any of a paper discharge unit 30 or the finisher 3.

In addition, at the rear end of the fixing unit 29, an image sensor Si that reads the image of the sheet subjected to the fixing may be provided. The image sensor Si functions as a sensor that senses image quality (for example, color information or tone information) of the image on the sheet subjected to the fixing. The image sensor Si reads the image on the sheet subjected to the fixing as image data. The image data as a sensing result by the image sensor Si is output to the system controller 5. The system controller 5 may detect image quality of the image actually printed on the sheet of paper by analyzing the image data from the image sensor Si.

The finisher 3 has a paper discharge mechanism 32 that processes the sheet on which the image is formed by the printer 2 and a paper discharge tray 33 on which the sheets are stacked. The finisher 3 may have a function of stapling the sheets stacked on the paper discharge tray 33 or a hole punching function.

In addition, the printer 2 illustrated in FIG. 2 is an electrophotographic printer. Here, the printer in this embodiment is not limited to the electrophotographic printer. This embodiment may also be applied to, for example, ink-jet or thermal transfer printers other than the electrophotographic printers.

The control panel 4 is a user interface. For example, a user inputs information such as setting information to the control panel 4. The control panel 4 is controlled by the system controller 5. The control panel 4 outputs the information input by the user to the system controller 5. In addition, the control panel 4 functions as a user authentication information input unit for inputting user authentication information by the user.

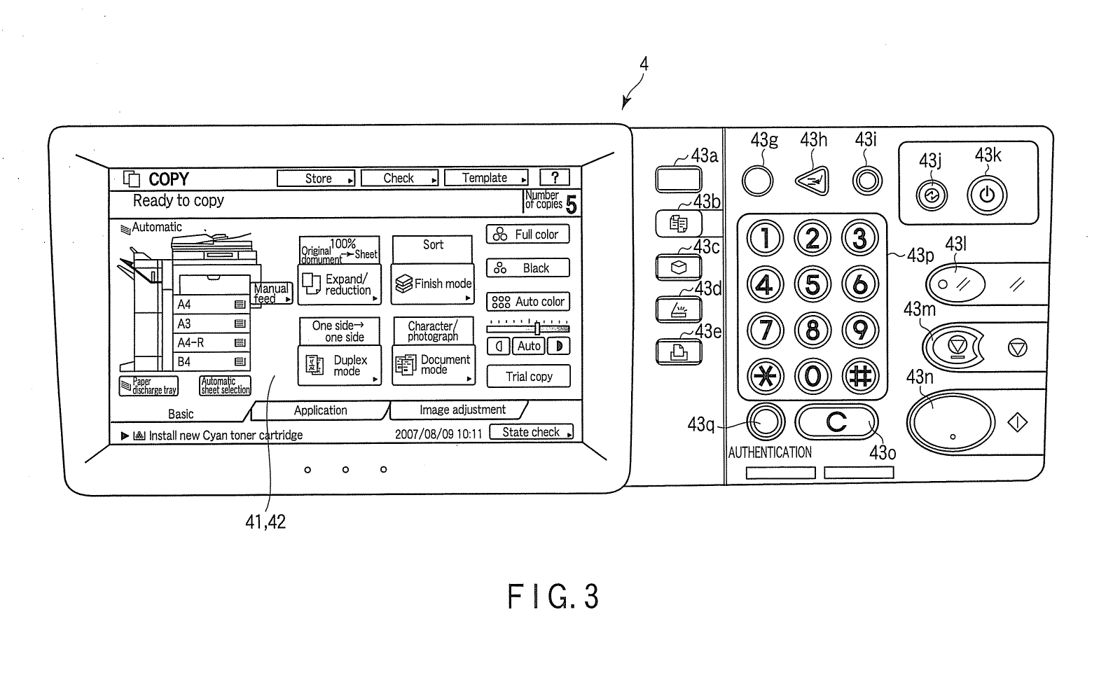

FIG. 3 is a diagram illustrating an example of the configuration of the control panel 4. In the example illustrated in FIG. 3, the control panel 4 has a display unit 41, a touch panel 42, and a plurality of operation buttons 43 (43a to 43p). The display unit 41 displays a guide. The display unit 41 has the touch panel 42 on a display screen. The touch panel 42 senses a site touched by the user on the display screen of the display unit 41. The user may select icons displayed by the display unit 41 using the touch panel 42.

The plurality of operation buttons 43 includes a menu button 43a, an operation mode selection button (copy button 43b), a filing box button 43c, a scan button 43d, a print button 43e, a setting registration button (setting button) 43g, an interrupt button 43h, a counter button 43i, a power waving button 43j, a power button 43k, a reset button 43l, a stop button 43m, a start button 43n, a clear button 43o, a numeric keypad 43p, and an authentication button 43q.

The menu button 43a is a button for instructing a menu screen to be displayed. The copy button 43b is a button for instructing a copy mode as an operation mode. The filing box button 43c is a button for instructing saved image data to be taken out. The scan button 43d is a button for instructing a scan mode as the operation mode. The print button 43e is a button for instructing a print mode as the operation mode for private printing or the like.

For example, if the copy mode is used, the user presses the copy button 43b. If the user presses the copy button 43b, the digital multi-functional peripheral operates in the copy mode. If the digital multi-functional peripheral is in the copy mode, the display unit 41 displays a copy setting screen. Immediately after the copy button 43b is pressed, the display unit 41 displays the copy setting screen that reflects default settings in the copy mode. In a state where the copy setting screen is displayed, the user can change setting contents to desired setting contents. For example, the number of copies may be changed by pressing the numeric keypad 43p. If the start button 43n is pressed, the digital multi-functional peripheral performs copying using the setting contents displayed on the display unit 41.

In order to use the scan mode, the user presses the scan button 43d. If the user presses the scan button 43d, the digital multi-functional peripheral operates in the scan mode. If the digital multi-functional peripheral is in the scan mode, the display unit 41 displays a scan setting screen. Immediately after the scan button 43d is pressed, the display unit 41 displays the scan setting screen that reflects default settings in the scan mode. In a state where the scan setting screen is displayed, the setting contents may be changed. If the start button 43n is pressed, the digital multi-functional peripheral performs scanning using the setting contents displayed on the display unit 41. For example, the digital multi-functional peripheral saves image data on a scanned original document in a destination designated by the user.

The setting button 43g is a button for instructing setting values to be registered. For example, if the setting button 43g is pressed, the user may perform setting or registration of a setting time (an automatic clearance setting time) to automatically clear the setting contents, switching of a language displayed on a guide screen or the like, adjustment of brightness of a display screen of a display device, adjustment of tone correction of toner images, position adjustment of the toner images on sheets, and the like. In addition, if the setting registration button 43g is pressed, the user may perform setting and registration including changing default values in each of the operation modes such as the copy mode, the scan mode, or a fax mode. The setting values such as the default values set by the user after pressing the setting button 43g are stored in a memory inside the system controller 5 which will be described later.

The interrupt button 43h is a button for instructing an interrupt process. The counter button 43i is a button for instructing a counter to be displayed. The power saving button 43j is a button for instructing a power waving mode as the operation mode. The power button 43k is a button for instructing power to be turned on. The reset button 43l is a button for clearing the setting contents to be returned to initial settings. The stop button 43m is a button for instructing the operation to be stopped. The start button 43n is a button for instructing the operation such as copying, scanning, or faxing to be started. The clear button 43o is a button for instructing numeric values such as the number of copies input using the numeric keypad 43p to be corrected. The numeric keypad 43p is a button for inputting numeric values such as the number of copies. The authentication button 43q is a button for instructing user authentication to be performed.

If the authentication button 43q is input, the control panel 4 functions as the authentication information input unit. The control panel 4 as the authentication information input unit acquires user authentication information input by the user. For example, if the user authentication information is numbers, the numeric keypad 43p may function as an authentication information input unit 6. In addition, if the user authentication information is information that can be input through the touch panel 42, the display unit 41 or the touch panel 42 may function as the authentication information input unit 6. Here, the authentication information input unit is not limited to the control panel 4 and may employ any device that can acquire user authentication information. For example, if the user authentication information is information stored in a storage medium such as an IC card, an interface that reads the user authentication information from the storage medium, such as an IC card reader, may be provided as the authentication information input unit.

If the authentication button 43q in the control panel 4 is input, the system controller 5 of the digital multi-functional peripheral performs user authentication. For example, if the authentication button 43q is input, the display unit 41 displays a guide to inputting user authentication information. The user inputs the user authentication information according to the guide displayed on the display unit 41. The system controller 5 performs a user authentication process by acquiring the user authentication information input by the user and collating the acquired user authentication information with authentication information on a registrant stored in the memory inside the apparatus (or a server connected to a network).

The configuration of a control system of the digital multi-functional peripheral configured as described above will be described.

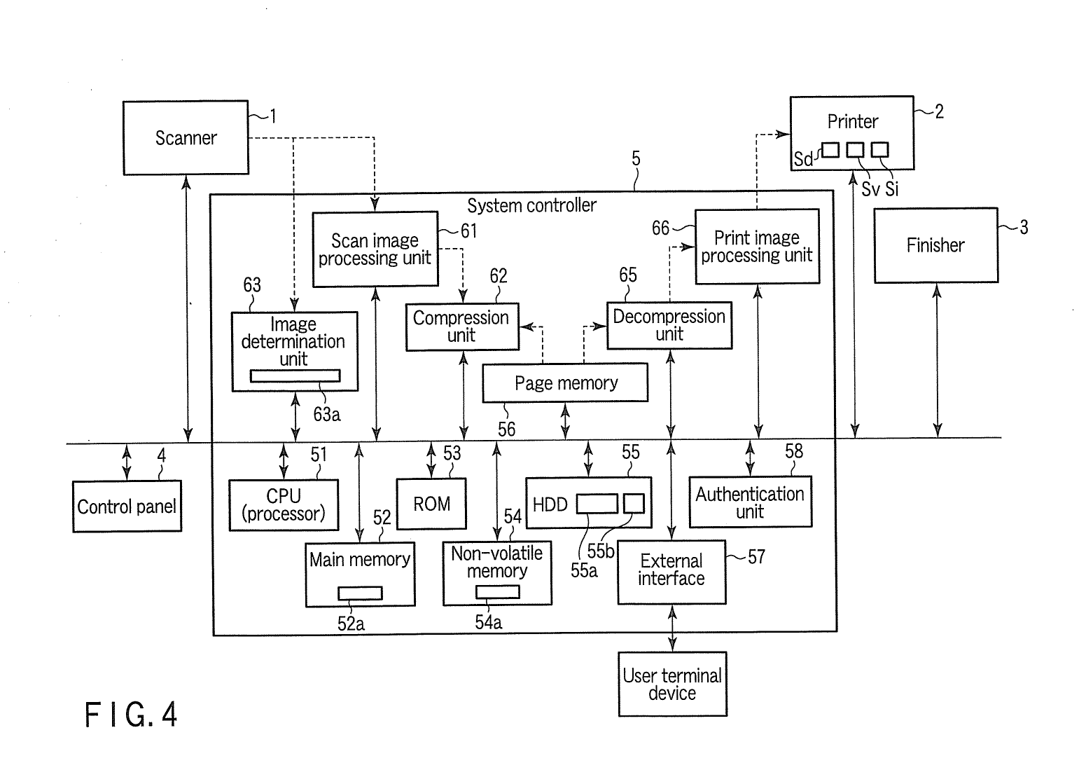

FIG. 4 is a block diagram for explaining the example of the configuration of the control system in the digital multi-functional peripheral.

The digital multi-functional peripheral has the system controller 5 that controls the entire apparatus. The system controller 5 is connected to the scanner 1, the printer 2, the finisher 3, the control panel 4, and the authentication information input unit 6 via a system bus or the like. The system controller 5 performs overall control of the scanner 1, the printer 2, the finisher 3, and the control panel 4.

The system controller 5 has a CPU (processor) 51, a main memory 52, a ROM 53, a non-volatile memory 54, an HDD 55, a page memory 56, an external interface (I/F) 57, a user authentication unit 58, a scan image processing unit 61, a compression unit 62, an image determination unit 63, a decompression unit 65, a print image processing unit 66, and the like.

The CPU 51 controls the overall digital multi-functional peripheral. The CPU 51 is a processor for realizing processes by executing programs. The CPU 51 is connected to each unit in the apparatus via the system bus. The CPU 51 is also connected to the scanner 1, the printer 2, the finisher 3, the control panel 4, the authentication information input unit 6, and the like via the system bus as well as to each unit in the system controller 5. The CPU 51 outputs an operation instruction to each unit or acquires various kinds of information from each unit through two-way communication with the scanner 1, the printer 2, and the control panel 4. In addition, the CPU 51 inputs information representing sensing signals and operation statuses of various sensors provided in each unit of the apparatus.

The main memory 52 is configured from a RAM or the like. The main memory 52 functions as a working memory or a buffer memory. The ROM 53 is a non-volatile memory storing programs, control data, and the like, which is not rewritable. The CPU 51 implements various processes by executing the programs stored in the ROM 53 (or the non-volatile memory 54 or the HDD 55) using the main memory 52.

In addition, the main memory 52 has a setting storage region 52a for storing current setting contents. For example, the CPU 51, first, loads default settings according to a process mode of the main memory 52 on the setting storage region 52a, and thereafter, changes each setting value according to a setting instruction of the user. Accordingly, current setting contents are stored in the setting storage region 52a of the main memory 52. The CPU 51 executes processes according to the setting contents stored in the setting storage region 52a of the main memory 52.

The non-volatile memory 54 is a rewritable non-volatile memory. The non-volatile memory 54 stores control programs executed by the CPU 51 and the control data. The non-volatile memory 54 has a default setting database 54a for storing default setting information. In addition, the non-volatile memory 54 is also a memory for storing conditions of a change reference for changing the default settings. For example, as for the conditions of the change reference for changing the default settings, a setting frequency (threshold value) for each setting value of each setting item in the default settings may be stored in the non-volatile memory 54.

The default setting database 54a stores default settings of each unit. In addition, the default settings include default settings in each of various process modes. The default settings are displayed as initial setting values, for example, on the setting screen displayed on the display unit 41 of the control panel 4 or a setting screen displayed by a display device of an external device by a printer driver. In addition, the default settings stored in the default setting database 54a include initial values of process parameters of each process mode.

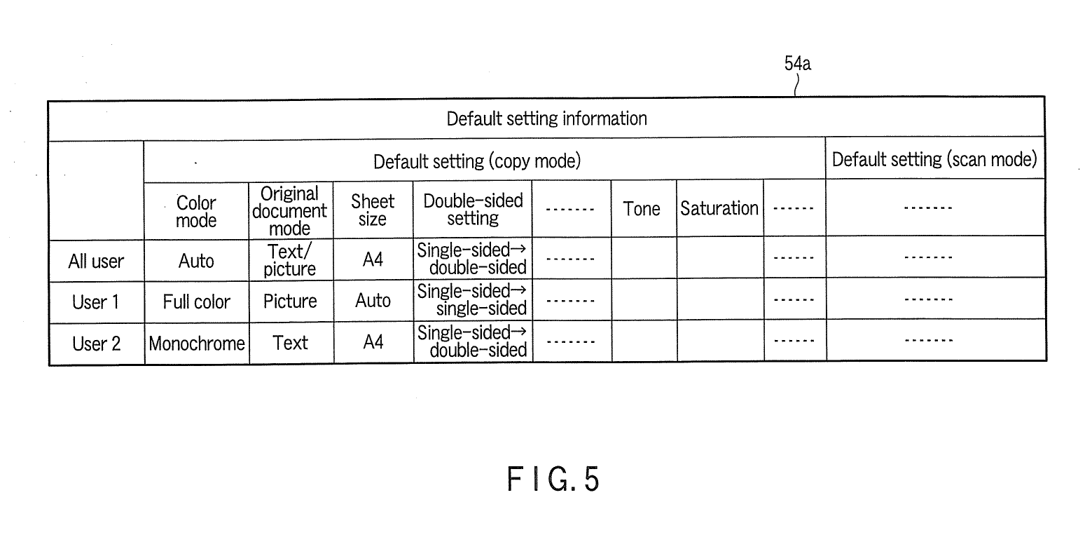

FIG. 5 is a diagram illustrating an example of the configuration of the default setting database 54a. In the example illustrated in FIG. 5, the default setting database 54a stores default settings for unspecified users (ALL USER) and default settings for each user authorized by the authentication process of the authentication unit 58. Moreover, the default setting database 54a stores default settings for each of the process modes such as the copy mode, the scan mode, the filing mode, and the print mode, as the default settings for each user.

The hard disk drive (HDD) 55 is a mass storage device. The HDD 55 stores image data, various kinds of log information, and the like. In addition, the HDD 55 may store authentication information about registrants which are objects of the user authentication process. Here, the authentication information about the registrants which are the objects of the user authentication process may be stored in an external device such as a server capable of performing communication via an external interface. In addition, the HDD 55 may store the default setting information or store the current setting contents instead of the non-volatile memory 54. The HDD 55 may store the control programs, the control data, and the like.

In addition, the HDD 55 has a setting log database 55a and an aggregation database 55b. The setting log database 55a accumulates setting information (setting log information) representing setting contents of processes executed in the past. The aggregation database 55b saves aggregated data that aggregates the setting log information.

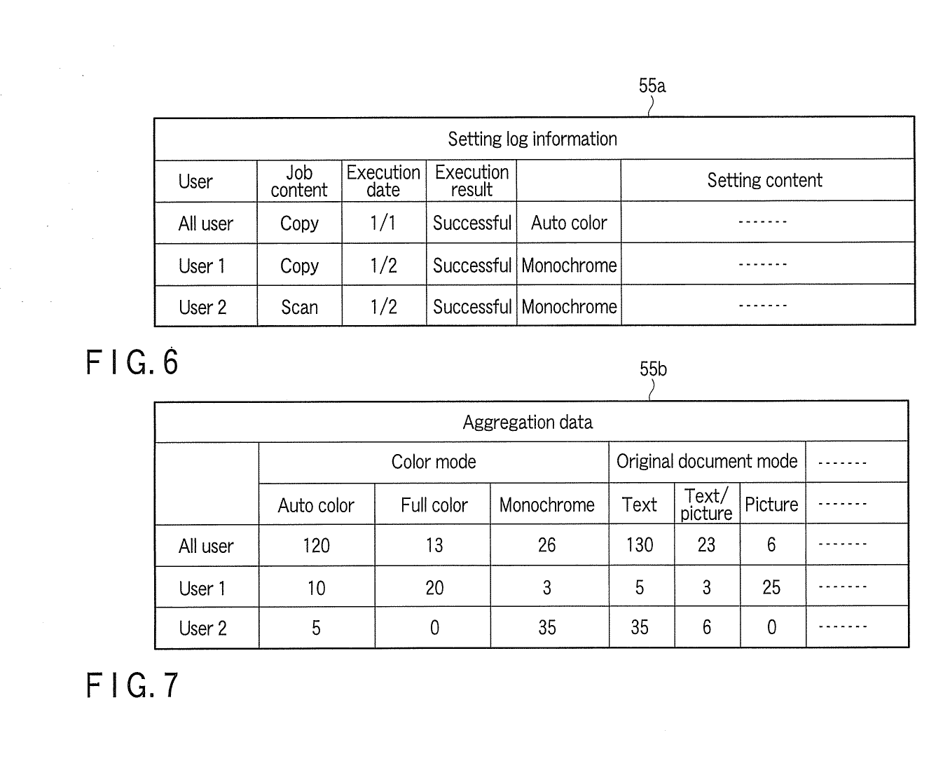

The setting log database 55a accumulates not only the setting information on the executed processes but also information representing results sensed by each sensor in the apparatus during the executed processes. FIG. 6 shows an example of the configuration of the setting log database 55a. In the example shown in FIG. 6, the setting log database 55a stores, in addition to the name of a user who instructs the process, process contents, process date, and process results of the executed process (job), setting contents of the corresponding job, setting parameters, sensing results of each sensor during the execution of the job, and the like.

In addition, the aggregation database 55b stores the aggregated data that aggregates the setting log information stored in the setting log database 55a. FIG. 7 is a diagram showing an example of the configuration of the aggregation database 55b. In the example shown in FIG. 7, the aggregation database 55b stores values aggregating setting counts and the like for each setting item. In addition, the aggregation database 55b also stores data that statistically aggregates the sensing results of each sensor.

The page memory 56 is a memory that deploys image data as an object to be processed. For example, the image data read by the scanner 1 is stored in the page memory 56 subjected to image processing. The image data stored in the page memory 56 is output to the printer 2 subjected to image processing for printing, is saved in the HDD 55, or is transmitted to an external device via the external interface 57.

The external interface 57 is an interface that performs data communication with an external device. For example, the external interface 57 is a network interface for communicating with the external device via a network. For example, if a print process requested from the external device is to be executed, the external interface 57 functions as an interface for acquiring setting information on the print process from the external device or acquiring image data for printing.

The user authentication unit 58 authenticates a user using user authentication information input by the user. The user authentication unit 58 determines whether or not the user is a registrant by collating the user authentication information input by the user with authentication information on the registrant. The authentication information on the registrant (dictionary data) may be saved in the HDD 55 or saved in an external device such as a server device that is accessible via the external interface 57.

In addition, the scan image processing unit 61, the compression unit 62, the image determination unit 63, the decompression unit 65, and the print image processing unit 66 have an image processing function in the system controller 5.

The scan image processing unit 61 processes image data read by the scanner 1 from an original document. The scan image processing unit 61 performs image processing on the image data acquired by the scanner 1 according to set parameters. For example, the scan image processing unit 61 performs resolution conversion, brightness adjustment, contrast adjustment, color saturation adjustment, sharpness adjustment, and the like on the image data acquired by the scanner 1. In addition, if the image data acquired by the scanner 1 is used in a plurality of processes, the scan image processing unit 61 may output a plurality of pieces of image data which are processed by each of the processes.

The compression unit 62 compresses the image data acquired by the scan image processing unit 61. The compression unit 62 stores the compressed image data in the page memory 56. In addition, the compression unit 62 may output the compressed image data to the HDD, the external interface, or the like. That is, the image data compressed by the compression unit 62 may be saved in the HDD 55 or be transmitted to an external device such as a user terminal device via the external interface 57.

The image determination unit 63 determines an image state by analyzing the image read by the scanner 1. The image determination unit 63 has, for example, an auto color mode determining function. The auto color mode determining function is a function determining whether the image of the original document read by the scanner 1 is in full color, or monochrome. The auto color mode determining function performed by the image determination unit 63 will be described later.

The decompression unit 65 decompresses image data. The decompression unit 65 reads out the compressed image data from the page memory 56 and decompresses the compressed image data. The decompression unit 65 outputs the decompressed image data to the print image processing unit 66. In addition, the decompression unit 65 may output the decompressed image data to the HDD 55, the external interface 57, or the like. That is, the image data decompressed by the decompression unit 65 may be saved in the HDD 55 or be transmitted to an external device such as a user terminal device via the external interface 57.

Next, an example of the job that can be executed by the digital multi-functional peripheral configured as described above will be described.

For example, in the digital multi-functional peripheral, as the operation modes in which the user inputs setting information using the control panel 4, there are the copy mode, the scan mode, the filing mode, the print mode, and the like. In addition, the digital multi-functional peripheral has a network print mode in which the user inputs setting information using the user terminal device (external device) having a printer driver operated.

For example, if the user instructs the copy button 43b, the CPU 51 displays the copy setting screens while reflecting the default settings of the copy mode on the display unit 41. In addition, if there is no instruction of the process modes, the CPU 51 may display the copy setting screen reflecting the default settings of the copy mode on the display unit 41. In addition, if the user instructs the scan button 43d, the CPU 51 displays the scan setting screen while reflecting the default settings of the scan mode on the display unit 41. In addition, it is possible to notify each user terminal device of the default setting information included in the printer driver from the digital multi-functional peripheral.

In addition, on the copy setting screen or the scan setting screen, a copy and file function may be selected. The copy and file function is a function of executing the copy process and the scan process on a single original document in parallel. For example, in the copy and file function, for example, it is possible to designate a resolution of the copy process or a resolution of image data saved by the scan process.

In the copy and file function, the CPU 51 sets a parameter in the image processing for copying such as a resolution or a parameter in the image processing for scanning in the scan image processing unit 61 on the basis of the setting information instructed by the user through the control panel 4. In this case, the CPU 51 may load, first, the default settings of the copy and file function and change the setting contents according to the instruction of the user.

For example, in the copy and file function, it is assumed that in many cases, the resolution of the image data saved as a file by the scan process is set to be lower than a reading resolution of the copy process at a request for reductions in data amount. The settings of the resolution in the copy and file function may be set to the default settings. For example, with regard to the default settings of the copy and file function, it is possible to set the resolution of the image processing for scanning to be lower than the reading resolution of the copy process. In addition, it is possible to update the default settings by a learning function for each user, which will be described later. That is, with regard to the default settings of the copy and file function, the resolution of the image processing for scanning may be set to a resolution that the users frequently set.

In addition, the image data read by the scanner 1 is input to the scan image processing unit 61. In many cases, the resolutions set for the image processing for copying and the image processing for scanning are different. Accordingly, the scan image processing unit 61 executes the image processing for copying and the image processing for scanning in parallel. The scan image processing unit 61 stores the image data obtained by the image processing for copying in the page memory 56 as image data for printing, and stores the image data obtained by the image processing for scanning in the page memory 56 as image data for scanning. The image data for printing is output to the printer 3 via the print image processing unit 66 or the like and is printed on the image forming medium by the printer 3. In addition, the image data for scanning is converted to a predetermined image format by a hardware accelerator or the like to be saved in the HDD 55 or the like.

In the copy and file function, while the copy process is executed, file writing of image data is executed in parallel therewith. Accordingly, the copy process and the scan process can be executed with good efficiency. Here, as the resolution of the image data that the user wants to leave as a file is increased, a large storage capacity is needed for the page memory. If the resolution is lower than a predetermined resolution, an operation in which performance is of importance is possible by simultaneously storing the image data for copying and filing in the page memory.

In addition, if a resolution higher than the predetermined resolution is designated for the image data for scanning, only a pass for copying is made effective, and the image data for copying which is stored in the page memory is written by converting the image data stored in the HDD into the image data for filing. Accordingly, it is possible to ensure the copy and file function while suppressing consumption of a storage capacity of the page memory.

Next, a color mode determining function 63a performed by the image determination unit 63 will be described.

The image determining unit 63 determines whether input image (the image read by the scanner 1) is in color, or monochrome by performing the color mode determining function 63a. The scanner 1 is a color scanner that reads the value of each pixel as a density value of a red component (R), a green component (G), and a blue component (B). In this case, whether or not each pixel is a color pixel can be determined by the density values of the red component (R), the green component (G), and the blue component (B). For example, color components of the color pixels vary (differences between density values of the components in monochrome pixels are small). In consideration of this, basically, as described later, a difference between components is equal to or greater than a predetermined threshold value, the pixel having the difference may be determined as a color pixel.

|R−G|>TH1, |G−B−>TH2, |B−R″>TH3

According to the determination result of whether or not a pixel is a color pixel as described above, whether or not the entire image data is in full color (hereinafter, simply called color), or monochrome can be determined.

The color mode determining function 63a of the image determination unit 63 may determine a color mode (whether in color, or monochrome) of an original document using a count value Cnt of color pixels in image data (input image data) on the original document. In this case, the image determination unit 63 determines the color mode of the original document on a determination reference as follows using the count value Cnt of the color pixel in the image data on the original document.

Cnt<THb determines monochrome.

THc≦Cnt determines color pixels.

Here, THb<THc.

With regard to the color mode determination as described above, the determination reference for determining whether the original document is in color, or monochrome can be set by changing setting values of THb and THc. For example, by increasing the value of THb, the original document is more likely to be determined as monochrome. In addition, by decreasing the value of THc, the original document is more likely to be determined as color.

In addition, the color mode determining function 63a of the image determination unit 63 may determine the color mode (whether in color or in monochrome) of the original document by the classification of the count value Cnt of the color pixel in the image data on the original document.

In this case, the image determination unit 63, first, determines whether or not the color mode of the original document is monochrome as follows.

a) In the case of Cnt<THb, monochrome is determined.

b) In the case of THc≦Cnt, it is determined that the color mode is other than monochrome (full color).

If the condition of b) is satisfied, and furthermore, if whether the color mode is full color needs to be determined, the image determination unit 63 classifies color pixels (color pixels made of components of R, G, and B) in the image data by a determination reference as follows. Whether or not the original document is in full color is determined.

In addition, the determination result of the color mode determination of the original document may be set by each user. For example, a user A may set full color and monochrome as the determination result of the color mode determination, a user B may set full color and monochrome as the determination result of the color mode determination, and a user C may set monochrome as the determination result of the color mode determination.

Moreover, the determination result of the color mode determination as described above may be set as default settings for each user. In this case, the determination result of the color mode determination as the default settings may be changed by setting log of each user.

In addition, the non-volatile memory 54 may store, as default settings for each user, threshold values used for the color mode determination in the default setting database 54a. In this case, the non-volatile memory 54 stores a change reference for a setting frequency of color setting obtained from the setting log information as a reference value for changing threshold values for the color determination as the default settings. Accordingly, the image processing apparatus can store parameters such as the threshold values used for the color determination as the default settings for each user, and moreover, update the default settings on the basis of the setting log information on each user.

Next, a learning function of default settings will be described.

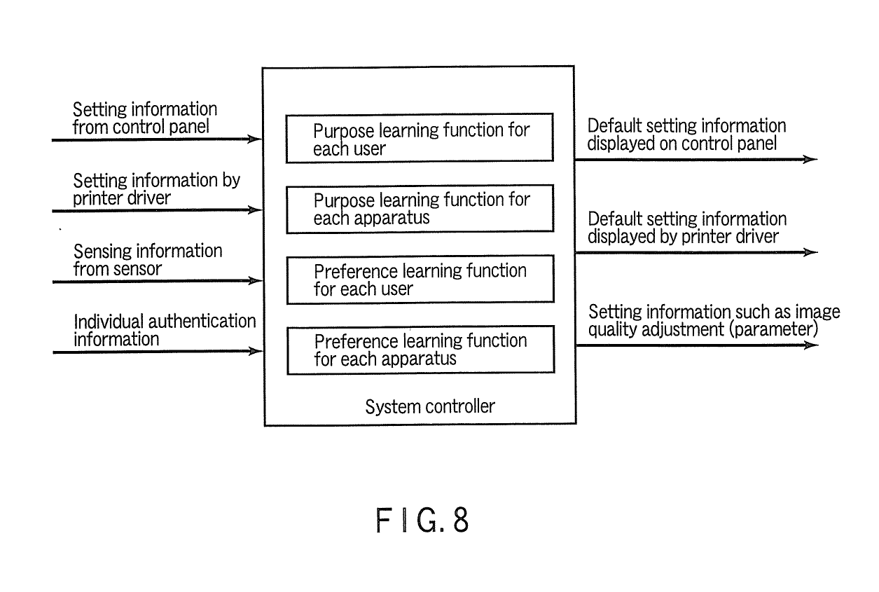

FIG. 8 is a diagram conceptually showing the learning function of the default settings.

The system controller 5 receives setting information from the user terminal device in which the printer driver is operated via the control panel 4 or the external interface 57. In addition, if a job is executed, the system controller 5 receives sensing information from the sensors that sense the apparatus status. The system controller 5 analyzes (aggregates) the setting information and the sensing information. For example, the system controller 5 analyzes (aggregates) the setting information and the sensing information on each user (or ALL users) that is authorized by the user authentication process.

The system controller 5 has a learning function of changing the default settings for each user using the aggregated setting information and sensing information. That is, the system controller 5 has a function of learning the default settings for each user or ALL users by analyzing (aggregating) the setting information and the sensing information for each user that is authorized by the user authentication process or ALL users. That is, the system controller 5 changes the default settings for each apparatus (the default settings for ALL users) or the default settings for each user to values that reflect purposes and preference information on image quality (original document mode, brightness adjustment, contrast adjustment, color saturation adjustment, sharpness adjustment, and the like).

The system controller 5 may adaptively change the setting information displayed as the initial setting screen on the control panel or the setting information displayed as the initial setting screen of the printer driver even though the user does not instruct the default settings to be changed. As a result, the image processing apparatus can provide default settings depending on the purposes or preference of the user even though the user does not instruct the default settings to be changed, thereby enabling setting depending on the preference of the user.

In addition, the sensors in the apparatus may sense information, for example, relating to image quality. Examples of sensor sensing information include color saturation information, tone information, and the like for each user. Such information can be sensed by, for example, the density sensor Sd. In addition, in order to sense image quality of an image forming medium after an image is printed thereon (for example, after the fixing process), the image sensor Si may be provided to sense information relating to image quality such as color saturation information or tone information. The system controller 5 adaptively change default setting values of the parameter used for the color conversion process or the tone correction process on the basis of the sensor sensing information. As a result, even though the user does not instruct the default settings to be changed, the image processing apparatus can provide the default settings depending on the preference of the users, thereby enabling settings depending on the preference of the users.

Next, an example of operations of the learning function will be described.

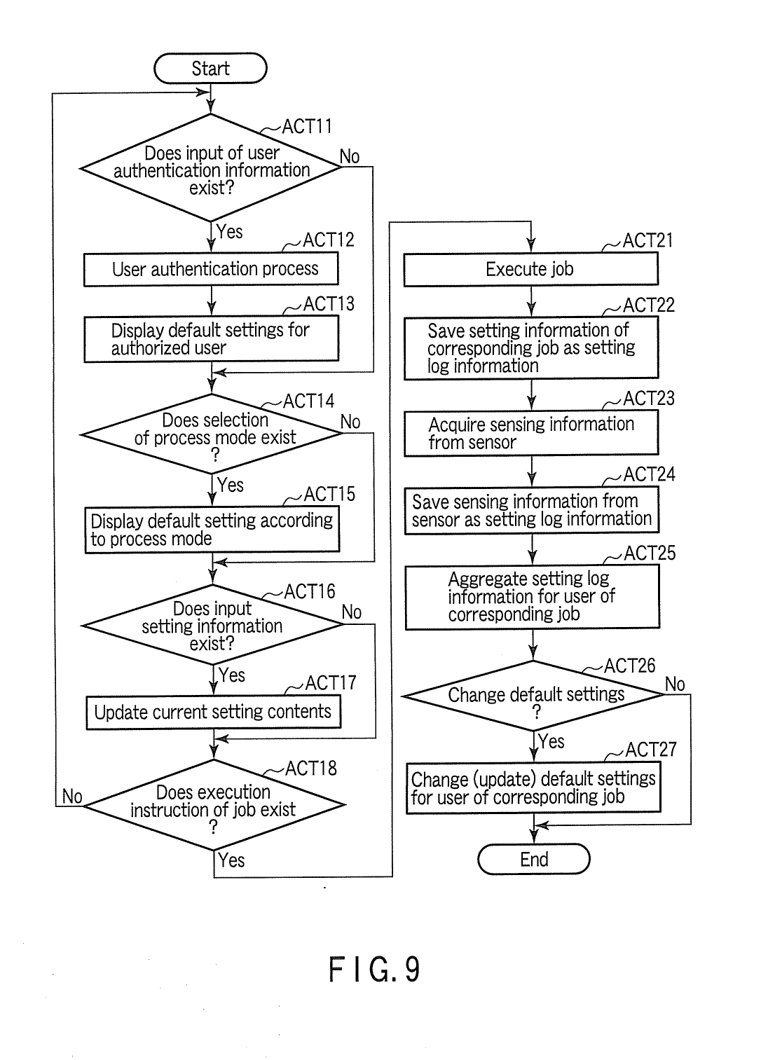

FIG. 9 is a flowchart for explaining the learning function of default settings.

In a standby state of the digital multi-functional peripheral, the CPU 51 of the system controller 5 displays the main menu screen, or the setting screen that reflects the default settings for all users in a default process mode (for example, the copy mode) on the display unit 41 of the control panel 4.

If the authentication button 43q is input in this state, the CPU 51 is set to an input standby state for user authentication information and receives authentication information input by a user. If the user authentication information is input (YES in ACT 11), the CPU 51 performs the user authentication process on the user authentication information input through the user authentication unit 58 (ACT 12). If the user authentication process is successful, the CPU 51 changes current setting contents stored in the setting storage region 52a of the main memory 52 to default settings of the authorized user (ACT 13).

That is, if the user authentication is successful, the CPU 51 reads out the default settings of the authorized user from the default setting database 54a. The CPU 51 changes the current setting contents stored in the setting storage region 52a to the default settings of the authorized user which are read out from the default setting database 54a. Accordingly, the CPU 51 updates the setting screen displayed on the display unit 41 of the control panel 4 to the default settings of the authorized user.

In addition, if a selection button of any of the process modes is input through the control panel 4 (YES in ACT 14), the CPU 51 switches to the process mode corresponding to the input button. In this case, the CPU 51 changes the current setting contents stored in the setting storage region 52a of the main memory 52 to the default settings of the process mode of the input button (ACT 15). That is, the CPU 51 reads out the default settings of the input process mode from the default setting database 54a. The CPU 51 changes the current setting contents stored in the setting storage region 52a to the default settings read out from the default setting database 54a. Accordingly, the CPU 51 updates the setting screen displayed on the display unit 41 of the control panel 4 to the default settings of the designated process mode.

In addition, if the setting information is input through the control panel 4 (YES in ACT 16), the CPU 51 updates the current setting contents stored in the setting storage region 52a according to the input button (Act 16). In addition, if the current setting contents are input, the CPU 51 updates the setting contents displayed on the setting screen of the display unit 41 according to the updated current setting contents.

In addition, if a job is instructed to be executed (YES in ACT 18), the CPU 51 executes the job on the basis of the current setting contents stored in the setting storage region 52a (ACT 21). If the job is instructed to be executed, the CPU 51 confirms the current setting contents as setting contents of the executed job. If setting information on the job is confirmed, the CPU 51 saves the setting contents of the corresponding job in the setting log database 55a as the setting log information (ACT 22). In this case, as the setting log information, for example, as shown in FIG. 5, setting information relating to process contents in addition to contents of the corresponding job, the name of the user who instructs the job to be executed, and execution date is stored.

In addition, during the execution of the job, the CPU 51 acquires sensing information from each sensor in the digital multi-functional peripheral (ACT 23). The CPU 51 saves the sensing information or the like relating to the settings of the process parameters from the sensing information acquired by each sensor in the setting log database 55a as the setting log information on the job (ACT 24).

As the setting log information on the job is saved, the CPU 51 aggregates setting log information related to the user of the job (ACT 25). For example, the CPU 51 aggregates a setting count or the like for each setting item as aggregation data on the setting log information relating to the user who instructs the job to be executed, using the setting log information saved in the setting log database 55a. In addition, the CPU 51 statistically aggregates the sensing information or the like obtained by each sensor from the setting log information relating to the user who instructs the job to be executed.

The CPU 51 saves the aggregation data aggregated for each user in the aggregation database 55b. If the setting log information is aggregated, the CPU 51 determines whether or not to change the default settings for each user on the basis of the aggregation data for each user (ACT 26). If it is determined that the default settings are to be changed (YES in ACT 26), the CPU 51 updates the default settings about the job stored in the default setting database 54a of the non-volatile memory 54 (ACT 27).

For example, the CPU 51 may determine that there is a setting item in the default settings to be changed by whether or not there is a setting item in the aggregation data, of which the setting count exceeds a frequency (threshold value) as a predetermined change reference. If the setting item of which the setting count exceeds the frequency as the setting reference, the CPU 51 changes the setting value of the setting item that exceeds the frequency as the change reference in the default settings. In addition, the CPU 51 may determine a tendency of image quality by settings selected by the user from the sensing information or the like on each sensor that can be obtained by aggregating the setting log information. In this case, the CPU 51 adjusts parameters and the like used for the image processing according to the image quality tendency by the settings from each user in the past.

In addition, existence of a change in the default settings is not only limited by determining the setting count. For example, the non-volatile memory 54 stores a condition of the change reference for changing the default settings in advance. The condition for changing the default settings may be set by each user, a system manager, or an employee. If the aggregation data on the setting log information satisfies the condition of the change reference for changing the default settings, the CPU 51 may determine that the default settings are to be changed.

In addition, the example of the operations of the learning function can be applied to a case where the printer driver is operated and setting information is input to the user terminal device connected to the digital multi-functional peripheral via the external interface 57. In this case, the display unit of the user terminal device capable of communicating with the digital multi-functional peripheral via the external interface 57 as the printer driver is operated displays the setting screen. In addition, the operation unit of the user terminal device capable of communicating with the digital multi-functional peripheral via the external interface 57 as the printer driver is operated functions as the input unit for inputting the user authentication information, setting information, or the like. In addition, the default settings by the printer driver may be notified to the user terminal device having the printer driver operated via the external interface 57 from the digital multi-functional peripheral.

The image processing apparatus according to this embodiment accumulates setting contents during an executed process as setting log information and learns a tendency of settings determined by a plurality of pieces of the accumulated setting log information, thereby updating default settings for each user or for each apparatus. Accordingly, the image processing apparatus according to this embodiment can provide initial settings depending on purposes or preference of the users even though the user does not set the default settings again, thereby enabling settings depending on the used status of the apparatus or the preference of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a storage unit that stores default settings;
a display unit that displays setting contents reflecting the default settings stored in the storage unit;
a display control unit that causes the setting contents which are changed in response to an instruction from a user to be displayed on the display unit;
a setting log saving unit that, if image processing is executed using the setting contents displayed on the display unit, saves the setting contents of the executed process as setting log information;
a determination unit that determines whether or not the default settings stored in the storage unit are to be changed using a plurality of pieces of the setting log information saved in the setting log saving unit; and
an updating unit that, if it is determined that the default settings are to be changed by the determination unit, updates the default settings stored in the storage unit to default settings determined from the plurality of pieces of the setting log information saved in the setting log saving unit.

2. The apparatus according to claim 1, further comprising a memory that stores a condition representing a change reference of the default settings stored in the storage unit,
wherein the determination unit determines that the default settings are to be changed, if aggregation data that aggregates the setting log information saved in the setting log saving unit satisfies the condition representing the change reference of the default settings stored in the memory.

3. The apparatus according to claim 2,
wherein the memory stores a setting frequency as the change reference for a setting value of a setting item included in the default settings, and
the determination unit determines whether or not the default settings are to be changed by whether or not the setting item of which the setting frequency is equal to or higher than the frequency as the change reference of the default settings exists from among the setting items saved as the setting log information in the setting log saving unit.

4. The apparatus according to claim 3, wherein the updating unit changes the setting value of the setting item of which the setting frequency is determined to be equal to or higher than the frequency as the change reference by the determination unit to the setting value that is equal to or higher than the frequency as the change reference, in the default settings stored in the storage unit.

5. The apparatus according to claim 1, further comprising an authentication unit that authenticates whether or not a user is a registrant by user authentication information input by the user,
wherein the storage unit stores default settings for each user as the registrant which is an object of authentication by the authentication unit, and
the display unit displays setting contents that reflect the default settings corresponding to the user authorized as the registrant by the authentication unit.

6. The apparatus according to claim 5,
wherein the storage unit stores the default settings for each registrant which is the object of authentication by the authentication unit and default settings for unspecified users who do not need authentication by the authentication unit, and
if the authentication unit authenticates the registrant, the display unit displays the setting contents reflecting the default settings corresponding to the user, and if the authentication by the authentication unit is not successful, the display unit displays the setting contents reflecting the default settings for the unspecified users.

7. The apparatus according to claim 1, further comprising a scanner that reads an image of an original document,
wherein the storage unit stores default settings for processing the image read by the scanner.

8. The apparatus according to claim 7, further comprising a color determination unit that determines color of the image of the original document read by the scanner,
wherein the storage unit stores the default settings including a threshold value used for the color determination by the color determination unit.

9. The apparatus according to claim 8, wherein the determination unit determines whether or not the threshold value of the color determination is to be changed in the default settings by a frequency of color settings in the setting log information saved in the setting log saving unit.

10. The apparatus according to claim 1, further comprising an image forming unit that forms an image on an image forming medium,
wherein the storage unit stores default settings for processing the image formed on the image forming medium.

11. The apparatus according to claim 10, further comprising a sensor that senses image quality of the image formed on the image forming medium by the image forming unit,
wherein the storage unit stores default settings including parameters for the image processing, and
the setting log saving unit saves the setting log information including sensing information sensed by the sensor.

12. The apparatus according to claim 11, wherein the determination unit determines whether or not the parameters for the image processing included in the default settings are to be changed, by the sensing information from the sensor included in the setting log information saved in the setting log saving unit.

13. A setting method used in an image processing apparatus, comprising:
storing default settings in a memory;
displaying setting contents reflecting the default settings stored in the memory on a display unit;
causing the setting contents which are changed in response to an instruction from a user to be displayed on the display unit;
if image processing is executed using the setting contents displayed on the display unit, saving the setting contents of the executed process on the saving unit as setting log information;
determining whether or not the default settings stored in the memory are to be changed using a plurality of pieces of the setting log information saved; and
if it is determined that the default settings are to be changed by the determining, updating the default settings stored in the memory to default settings determined from the plurality of pieces of the setting log information.

14. The method according to claim 13, further comprising storing a condition representing a change reference of the default settings in the memory,
wherein, in the determining, if aggregation data that aggregates the plurality of pieces of the setting log information satisfies the condition representing the change reference of the default settings, it is determined that the default settings are to be changed.

15. The method according to claim 14,
wherein the condition representing the change reference of the default settings is a setting frequency as the change reference for a setting value in a setting item included in the default settings, and
in the determining, it is determined whether or not the default settings are to be changed by whether or not the setting item of which the setting frequency is equal to or higher than the frequency as the change reference of the default settings exists from among the setting items in the plurality of pieces of the setting log information.

16. The method according to claim 15, wherein, in the updating, the setting value of the setting item of which the setting frequency is determined to be equal to or higher than the frequency as the change reference by the determining is changed to the setting value that is equal to or higher than the frequency as the change reference in the default settings.

17. The method according to claim 13, further comprising:
authenticating whether or not a user is a registrant by user authentication information input by the user,
wherein the default settings are set for each user as the registrant which is an object of authentication by the authenticating, and
displaying setting contents that reflect the default settings corresponding to the user authorized as the registrant by authenticating on the display unit.

18. The method according to claim 13,
wherein image processing is performed on an image read by a scanner, and
parameters of the image processing for the image read by the scanner are included in the default settings.

19. The method according to claim 13, further comprising forming an image on an image forming medium,
wherein parameters for a process of forming the image on the image forming medium are included in the default settings.

20. The method according to claim 19, further comprising sensing image quality of the image formed in the image forming medium by a sensor,
wherein the parameters for the process of forming the image on the image forming medium are included in the default settings,
the setting log information including sensing information sensed by the sensor is saved as the setting log information, and
in the determining, whether or not the parameters for forming the image on the image forming medium included in the default settings are to be changed, by the sensing information from the sensor in the plurality of pieces of the setting log information.
